(19) United States
(12) Patent Application Publication
(10) Pub. No.: US 2010/0093354 A1
(43) Pub. Date: Apr. 15, 2010

(54) SYSTEM AND METHOD TO UTILIZE PRE-ASSIGNED RESOURCES TO SUPPORT HANDOFF OF A MOBILE STATION FROM A MACRO BASE STATION TO A FEMTO BASE STATION

(75) Inventors: Parag A. Agashe, San Diego, CA (US); Peerapol Tinnakornsrisuphap, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/573,534

(22) Filed: Oct. 5, 2009

Related U.S. Application Data
(60) Provisional application No. 61/104,224, filed on Oct. 9, 2008.

(51) Int. Cl. H04W 36/00

(52) U.S. Cl. 455/436

(57) ABSTRACT

Apparatus and methods of hand-in of a call from a macro node to a femto node include receiving, at a target interface to a plurality of access points, a handoff request to handoff a call of a mobile station, wherein the handoff request comprises a cellular identifier corresponding to a pilot identifier of a pilot signal. Further, the apparatus and methods include determining that the plurality of access points share the cell identifier, and forwarding the handoff request to the plurality of access points that share the cell identifier. Additionally, the apparatus and methods include generating a handoff request acknowledgement comprising a pre-reserved resource that is common to the plurality of access points, wherein the pre-reserved resource enables the mobile station to communicate with the plurality of access points, and transmitting the handoff request acknowledgement to initiate the hand-in to one of the plurality of access points.

### CLAIM OF PRIORITY UNDER 35 U.S.C. §119

The present Application for Patent claims priority to Provisional Application No. 61/104,224 entitled “SYSTEM AND METHOD TO UTILIZE PRE-ASSIGNED RESOURCES TO SUPPORT HANDOFF OF A MOBILE STATION FROM A MACRO BASE STATION TO A FEMTO BASE STATION” filed Oct. 9, 2008, and assigned to the assignee hereof and hereby expressly incorporated by reference herein.

### BACKGROUND

1. Field

This application relates generally to wireless communication and more specifically, but not exclusively, to systems and methods to support a hand-in of a call to an access point base station, also known as femto cell.

2. Introduction

Wireless communication systems are widely deployed to provide various types of communication (e.g., voice, data, multimedia services, etc.) to multiple users. As the demand for high-rate and multimedia data services rapidly grows, there lies a challenge to implement efficient and robust communication systems with enhanced performance.

To supplement conventional mobile phone network base stations, additional base stations may be deployed to provide more robust wireless coverage to mobile units. For example, wireless relay stations and small-coverage base stations (e.g., commonly referred to as access point base stations, Home NodeBs, femto access points, or femto cells) may be deployed for incremental capacity growth, richer user experience, and in-building coverage. Typically, such small-coverage base stations are connected to the Internet and the mobile operator's network via DSL router or cable modem. As these other types of base stations may be added to the conventional mobile phone network (e.g., the backhaul) in a different manner than conventional base stations (e.g., macro base stations), there is a need for effective techniques for managing these other types of base stations and their associated user equipment.

As a mobile unit moves throughout a given geographical area, the mobile unit may need to be handed-off from one of the base stations of the wireless communication system to another base station. In such a system, small-coverage base stations may be deployed in an ad-hoc manner. For example, small-coverage base stations may be deployed based on the individual decision of owners that install the base stations. Thus, in a given area there may be a relatively large number of these small-coverage base stations to which the mobile unit may be handed-off. In current handoff mechanisms, the source base station (BS) is currently configured with a mapping between a target BS/MSC and the corresponding pseudonoise (PN) offset in the pilot report. However, for femto cell hand-in, the hand-in target is ambiguous, as many femto cells in the geographical area may use the same PN offsets. Also, it is desirable to have no change to the existing air-interface specification and no change to the legacy macro base station and MSC.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, a method of performing a hand-in comprises receiving, at a target interface to a plurality of access points, a handoff request to handoff a call of a mobile station, wherein the handoff request comprises a cellular identifier corresponding to a pilot identifier of a pilot signal. The method also includes determining that the plurality of access points share the cell identifier, and forwarding the handoff request to the plurality of access points that share the cell identifier. Further, the method includes generating a handoff request acknowledgement comprising a pre-reserved resource that is common to the plurality of access points, wherein the pre-reserved resource enables the mobile station to communicate with the plurality of access points. Additionally, the method includes transmitting the handoff request acknowledgement to initiate the hand-in to one of the plurality of access points.

In another aspect, at least one processor for performing a hand-in comprises a first module for receiving, at a target interface to a plurality of access points, a handoff request to handoff a call of a mobile station, wherein the handoff request comprises a cellular identifier corresponding to a pilot identifier of a pilot signal. The at least one processor also includes a second module for determining that the plurality of access points share the cell identifier, and a third module for forwarding the handoff request to the plurality of access points that share the cell identifier. Further, the at least one processor includes a fourth module for generating a handoff request acknowledgement comprising a pre-reserved resource that is common to the plurality of access points, wherein the pre-reserved resource enables the mobile station to communicate with the plurality of access points. Additionally, the at least one processor includes a fifth module for transmitting the handoff request acknowledgement to initiate the hand-in to one of the plurality of access points.

In still another aspect, a computer program product for performing a hand-in comprises a computer-readable medium comprising a plurality of instructions. The instructions include at least one instruction operable to cause a computer to receive, at a target interface to a plurality of access points, a handoff request to handoff a call of a mobile station, wherein the handoff request comprises a cellular identifier corresponding to a pilot identifier of a pilot signal. Further, the instructions includes at least one instruction operable to cause the computer to determine that the plurality of access points share the cell identifier, and at least one instruction operable to cause the computer to forward the handoff request to the plurality of access points that share the cell identifier. Also, the instructions include at least one instruction operable to cause the computer to generate a handoff request acknowledgement comprising a pre-reserved resource that is common to the plurality of access points, wherein the pre-reserved resource enables the mobile station to communicate with the plurality of access points. Additionally, the instructions include at least one instruction operable to cause the computer to transmit the handoff request acknowledgement to initiate the hand-in to one of the plurality of access points.

In a further aspect, a target interface component for performing a hand-in comprises means for receiving, at a target interface to a plurality of access points, a handoff request to handoff a call of a mobile station, wherein the handoff request comprises a cellular identifier corresponding to a pilot identifier of a pilot signal. The component also includes means for determining that the plurality of access points share the cell identifier, and means for forwarding the handoff request to the plurality of access points that share the cell identifier. Further, the component includes means for generating a handoff request acknowledgement comprising a pre-reserved resource that is common to the plurality of access points, wherein the pre-reserved resource enables the mobile station to communicate with the plurality of access points. Additionally, the component includes means for transmitting the handoff request acknowledgement to initiate the hand-in to one of the plurality of access points.

In another aspect, a target interface component for performing a hand-in comprises a communications module configured to receive a handoff request to handoff a call of a mobile station, wherein the handoff request comprises a cellular identifier corresponding to a pilot identifier of a pilot signal. The component also includes a target access point determiner configured to determine a plurality of access points that share the cell identifier, to initiate forwarding the handoff request to the plurality of access points that share the cell identifier. Additionally, the communications module is further configured to generate a handoff request acknowledgement comprising a pre-reserved resource that is common to the plurality of access points, wherein the pre-reserved resource enables the mobile station to communicate with the plurality of access points, and to transmit the handoff request acknowledgement to initiate the hand-in to one of the plurality of access points.

In a further aspect, a method of performing a hand-in comprises transmitting, by an access point, a pilot signal including a pilot identifier, wherein the pilot identifier is common to a plurality of access points within a macro cell of a cellular network. Also, the method includes receiving a handoff request to receive a hand-in of a call of a mobile station, wherein the handoff request is destined for the access point based on a cellular identifier corresponding to the pilot identifier. Additionally, the method includes transmitting forward link traffic data according to a pre-reserved resource that is common to the plurality of access points to initiate the hand-in, wherein the pre-reserved resource enables the mobile station to communicate with the plurality of access points.

In still another aspect, at least one processor for performing a hand-in comprises a first module for transmitting, by an access point, a pilot signal including a pilot identifier, wherein the pilot identifier is common to a plurality of access points within a macro cell of a cellular network. Also, the at least one processor includes a second module for receiving a handoff request to receive a hand-in of a call of a mobile station, wherein the handoff request is destined for the access point based on a cellular identifier corresponding to the pilot identifier. Additionally, the at least one processor includes a third module for transmitting forward link traffic data according to a pre-reserved resource that is common to the plurality of access points to initiate the hand-in, wherein the pre-reserved resource enables the mobile station to communicate with the plurality of access points.

In another aspect, a computer program product for performing a hand-in comprises a computer-readable medium comprising a plurality of instructions. The instructions include at least one instruction operable to cause a computer associated with an access point to transmit a pilot signal including a pilot identifier, wherein the pilot identifier is common to a plurality of access points within a macro cell of a cellular network. Also, the instructions include at least one instruction operable to cause the computer to receive a handoff request to receive a hand-in of a call of a mobile station, wherein the handoff request is destined for the access point based on a cellular identifier corresponding to the pilot identifier. Additionally, the instructions include at least one instruction operable to cause the computer to transmit forward link traffic data according to a pre-reserved resource that is common to the plurality of access points to initiate the hand-in, wherein the pre-reserved resource enables the mobile station to communicate with the plurality of access points.

In a further aspect, an access point comprises means for transmitting a pilot signal including a pilot identifier, wherein the pilot identifier is common to a plurality of access points within a macro cell of a cellular network. Also, the access point includes means for receiving a handoff request to receive a hand-in of a call of a mobile station, wherein the handoff request is destined for the access point based on a cellular identifier corresponding to the pilot identifier. Additionally, the access point includes means for transmitting forward link traffic data according to a pre-reserved resource that is common to the plurality of access points to initiate the hand-in, wherein the pre-reserved resource enables the mobile station to communicate with the plurality of access points.

In yet another aspect, an access point comprises a communications module configured to transmit a pilot signal including a pilot identifier, wherein the pilot identifier is common to a plurality of access points within a macro cell of a cellular network, to receive a handoff request to receive a hand-in of a call of a mobile station, wherein the handoff request is destined for the access point based on a cellular identifier corresponding to the pilot identifier, and to transmit forward link traffic data according to a pre-reserved resource that is common to the plurality of access points to initiate the hand-in, wherein the pre-reserved resource enables the mobile station to communicate with the plurality of access points.

In a further aspect, a method of communication comprises receiving, at a mobile station located within a first cell, a pilot signal from an access point during a call carried by a source wireless network component different from the access point, wherein the pilot signal from the access point indicates a pilot identifier that is common to a plurality of access points within the first cell. The method also includes forwarding a measurement message including the pilot identifier to the source wireless network component, and receiving a handoff message that includes a pre-reserved resource that is common to the plurality of access points based on the pilot identifier, wherein the pre-reserved resource enables the mobile station to communicate with any of the plurality of access points. Additionally, the method includes receiving forward link traffic data from one of the plurality of access points, and handing off the call to the one of the plurality of access points from which the forward link traffic data is received.

In another aspect, at least one processor for communication comprises a first module for receiving, at a mobile station located within a first cell, a pilot signal from an access point during a call carried by a source wireless network component different from the access point, wherein the pilot signal from the access point indicates a pilot identifier that is common to a plurality of access points within the first cell. The at least one processor also includes a second module for forwarding a measurement message including the pilot identifier to the source wireless network component, and a third module for receiving a handoff message that includes a pre-reserved resource that is common to the plurality of access points based on the pilot identifier, wherein the pre-reserved resource enables the mobile station to communicate with any of the plurality of access points. Additionally, the at least one processor includes a fourth module for receiving forward link traffic data from one of the plurality of access points, and a fifth module for handing off the call to the one of the plurality of access points from which the forward link traffic data is received.

In still another aspect, a computer program product comprises a computer-readable medium comprising a plurality of instructions. The instructions include at least one instruction operable to cause a computer to receive, at a mobile station located within a first cell, a pilot signal from an access point during a call carried by a source wireless network component different from the access point, wherein the pilot signal from the access point indicates a pilot identifier that is common to a plurality of access points within the first cell. Further, the instructions include at least one instruction operable to cause the computer to forward a measurement message including the pilot identifier to the source wireless network component. Also, the instructions include at least one instruction operable to cause the computer to receive a handoff message that includes a pre-reserved resource that is common to the plurality of access points based on the pilot identifier, wherein the pre-reserved resource enables the mobile station to communicate with any of the plurality of access points. Additionally, the instructions include at least one instruction operable to cause the computer to receive forward link traffic data from one of the plurality of access points, and at least one instruction operable to cause the computer to hand off the call to the one of the plurality of access points from which the forward link traffic data is received.

In a further aspect, a mobile station comprises means for receiving, at a mobile station located within a first cell, a pilot signal from an access point during a call carried by a source wireless network component different from the access point, wherein the pilot signal from the access point indicates a pilot identifier that is common to a plurality of access points within the first cell. Also, the mobile station includes means for forwarding a measurement message including the pilot identifier to the source wireless network component, and means for receiving a handoff message that includes a pre-reserved resource that is common to the plurality of access points based on the pilot identifier, wherein the pre-reserved resource enables the mobile station to communicate with any of the plurality of access points. Additionally, the mobile station includes means for receiving forward link traffic data from one of the plurality of access points, and means for handing off the call to the one of the plurality of access points from which the forward link traffic data is received.

In another aspect, a mobile station comprises a processor and a memory comprising instructions executable by the processor to: receive, when the mobile station is located within a first cell, a pilot signal from an access point during a call carried by a source wireless network component different from the access point, wherein the pilot signal from the access point indicates a pilot identifier that is common to a plurality of access points within the first cell. The instructions are also executable to forward a measurement message including the pilot identifier to the source wireless network component, and receive a handoff message that includes a pre-reserved resource that is common to the plurality of access points based on the pilot identifier, wherein the pre-reserved resource enables the mobile station to communicate with any of the plurality of access points. Additionally, the instructions are executable to receive forward link traffic data from one of the plurality of access points, and hand off the call to the one of the plurality of access points from which the forward link traffic data is received.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

These and other sample aspects of the disclosure will be described in the detailed description and the appended claims that follow, and in the accompanying drawings, wherein:

FIG. 1 is a schematic diagram of the effects of a communication system configured to perform handoff operations in accordance with as aspect of the teachings herein;

FIG. 2 is a schematic diagram of an aspect of a wireless communication system including access points and access terminals operable to perform the handoff operations in accordance with as aspect of the teachings herein;

FIG. 3 is a schematic diagram of a wireless communication system including femto nodes operable to perform the handoff operations in accordance with as aspect of the teachings herein;

FIG. 4 is a schematic diagram of sample coverage areas for wireless communication in accordance with as aspect of the teachings herein;

FIG. 5 is a message flow diagram of an aspect of an operation of a communication system in accordance with as aspect of the teachings herein;

FIG. 6 is an aspect of a mapping between various identifiers used in the system described herein;

FIG. 7 is a schematic block diagram of an aspect of a mobile station of FIG. 5 in accordance with as aspect of the teachings herein;

FIG. 8 is a schematic block diagram of an aspect of a source BS of FIG. 5 in accordance with as aspect of the teachings herein;

FIG. 9 is a schematic block diagram of an aspect of a source MSC of FIG. 5 in accordance with as aspect of the teachings herein;

FIG. 10 is a schematic block diagram of an aspect of a target interface or target MSC of FIG. 5 in accordance with as aspect of the teachings herein;

FIG. 11 is a schematic block diagram of an aspect of a target femto AP of FIG. 5 in accordance with as aspect of the teachings herein;

FIG. 12 is a schematic block diagram of an aspect of a network interface component in accordance with as aspect of the teachings herein;

FIG. 13 is a schematic block diagram of an aspect of a femto base station in accordance with as aspect of the teachings herein;

FIG. 14 is a schematic block diagram of an aspect of a transmitter or mobile station in accordance with as aspect of the teachings herein; and

FIG. 15 is a schematic diagram of several sample aspects of communication components in accordance with as aspect of the teachings herein.

In accordance with common practice the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

The disclosure relates in some aspects to utilizing a pre-assigned resource for supporting an access point to which an access terminal is to be handed-off, also referred to as handed-in. For example, in some aspects, when an access terminal detects a pilot signal from an access point, there may be ambiguity as to the identity of the access point. For instance, in a situation where a number of the access points or femto base stations in a cell are greater than a number of unique pilot identifiers available in the cell, one or more subsets of the access points or femto base stations are assigned the same pilot identifier, such as a PN code or PN offset. As such, when an access terminal identifies a pilot signal from one of these subsets, the exact identity of the access point or femto base station is not known as it could be any one in the subset. In any case, the described aspects enable the system to send a handoff request to all of the access points or femto base stations in the subset sharing the detected pilot identifier, and to enable a hand-in to one of the access points or femto base stations in the subset. In some aspects, the access point or femto base station that receives the hand-in will be located closest to the access terminal.

More specifically, to enable the access terminal to detect and communicate with the access point or femto base station corresponding to the detected pilot signal, the described aspects provide for the one or more subsets of access points or femto base stations to reserve a common set of resources (e.g., a Walsh code) that can be assigned to the access terminal or mobile station during hand-in to enable communication. The common resource is assigned to the access terminal as part of the handoff process, and the access terminal tunes its receiver according to the common resource to receive traffic from one of the subset of access points or femto base stations. As such, the access terminal is able to receive forward link traffic data only from an access point or femto base station from the subset that has a forward link coverage in a location of the access terminal. So, for example, even though a plurality of the access points or femto base stations sharing the same pilot identifier receive the handoff request and subsequently transmit forward link data according to the common resource, those transmission are not received by the access terminal if the access terminal is outside of the forward link coverage of the respective access point or femto base station. In some aspects, such as through network planning or through performing local measurements, the described aspects further assign adjacent access points or femto base stations that have overlapping coverage with different PN offsets, thereby avoiding PN collisions and enabling the access points or femto base stations to be able to serve the access terminal. In any case, as a result of the described aspects, even though the pilot signal detected by the access terminal from the access point or femto base station having a shared pilot identifier was ambiguous in that an exact access point or femto base station was not identified, the aspects herein allow for a successful hand-in. After the hand-in succeeds (e.g., with the access point or femto base station closest to the mobile), the respective access point or femto base station may request the mobile to change from the common resource to a non-common resource associated with the access point or femto base station to facilitate subsequent communications.

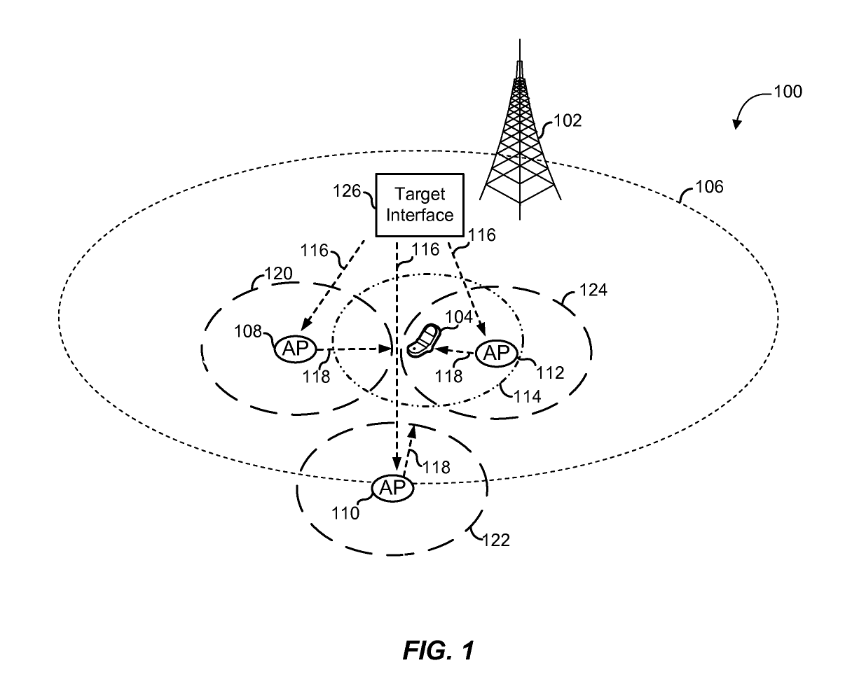

FIG. 1 is a simplified block diagram of the effects of a communication system 100 configured to perform handoff operations in accordance with the teachings herein. For illustration purposes, various aspects of the disclosure will be described in the context of one or more network nodes, access points, and access terminals that communicate with one another. It should be appreciated, however, that the teachings herein may be applicable to other types of apparatuses or other similar apparatuses that are referenced using other terminology.

In FIG. 1, before handoff or hand-in of a call from a macro node 102 to a femto node or femto access point (AP), a mobile station 104 may have a reverse link (RL) power strong enough to provide a transmission coverage area 106 that may be seen by many femto nodes or femto APs, such as APs 108, 110 and 112. In this case, for simplicity, the transmission coverage area 106 may also represent the coverage area of macro node 102, however, it should be understood that the mobile station transmission coverage area and the macro node coverage area may differ in size. After handoff, in one aspect, a femto AP to which a call is handed off, such as AP 112, may power control the RL power of mobile station 104 to provide a relatively smaller transmission coverage area 114, for example, such that a reverse link coverage of the mobile station is substantially equal to or less than a forward link coverage of the femto AP. In some aspects, for example, such power control results in a handoff completion message transmitted by mobile station 104 to be received only by a nearby AP, such as the closest access point, for example AP 112 in this case.

The above-described effect may be desirable in a system 100 where a number of available pilot identifiers, such as pseudonoise (PN) codes or PN offsets, used to uniquely identify each femto AP in a cell is less than a number femto APs present in the cell. As such, more than one femto AP may be assigned the same pilot identifier, thereby leading to a situation where a hand-in target identified by a source network component in the macro node 102 is ambiguous, e.g. a pilot identifier detected by mobile station 104 and reported to the source network component corresponds to more than one femto AP. Without changing the macro node or network air-interface specifications, the described aspects utilize the proximity of mobile station 104 and a femto AP to resolve this hand-in ambiguity. Specifically, to trigger the hand-in, a target interface component 126, such as a target mobile switching center, is configured to transmit a handoff triggering message 116, such as a handoff request, transmit to FAPs that are in the relatively larger coverage area 106 of the macro cell 102. Further, mobile station 104 obtains a pre-reserved resource that is common to the plurality of femto access points based on the pilot identifier, wherein the pre-reserved resource enables the mobile station to communicate with any of the plurality of femto APs. In response to handoff triggering message 116, each femto AP receiving message 116 sends forward link (FL) data 118, such as a null frame in order to enable mobile station 104 to confirm the handoff. Although a plurality of femto APs, such as APs 108, 110 and 112, transmit FL data 118 according to the common resource to which mobile station 104 is tuned, mobile station 104 only receives the forward link data 118 corresponding to the femto AP having a forward link coverage area, such as area 120, 122 or 124, in which mobile station 104 is located. In this case, for example, mobile station 104 receives FL data 118 from femto AP 112 as mobile station 104 is within FL coverage area 124, and outside of FL coverage areas 120 and 122 of femto APs 108 and 110, respectively. As such, the hand-in can be completed to femto AP 112 and mobile station 104 can be power-controlled to reduce RL transmit power to efficiently communicate with femto AP 112. Thus, the proximity of mobile station 104 to femto AP 112 is utilized to resolve the hand-in ambiguity between femto APs having common identification information, such as in a cell having more femto APs than available AP identification information.

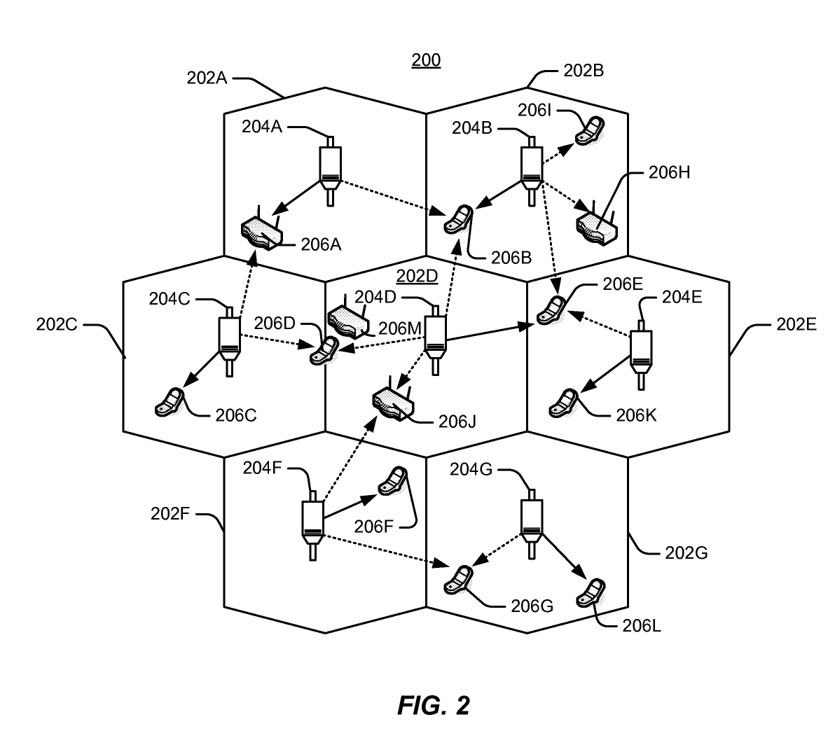

In the description herein, a node that provides coverage over a relatively large area (e.g., macro scale coverage, for example, a large area cellular network such as a 3G network or macro cell network) may be referred to as a macro node while a node that provides coverage over a relatively small area (e.g., smaller scale coverage, for example, a residence-based or building-based environment) may be referred to as a femto node. It should be appreciated that the teachings herein may be applicable to nodes associated with other types of coverage areas. For example, a pico node may provide coverage over an area that is smaller than a macro area and larger than a femto area (e.g., coverage within a commercial building). In various applications, other terminology may be used to reference a macro node, a femto node, or other access point-type nodes. For example, a macro node may be configured or referred to as an access node, base station, access point, eNodeB, macro cell, and so on. Also, a femto node may be configured or referred to as a Home NodeB, Home eNodeB, access point base station, femto cell, and so on. In some implementations, a node may be associated with (e.g., divided into) one or more cells or sectors. A cell or sector associated with a macro node, a femto node, or a pico node may be referred to as a macro cell, a femto cell, or a pico cell, respectively. A simplified example of how femto nodes may be deployed in a network will now be described with reference to FIGS. 2-4.

FIG. 2 illustrates a wireless communication system 200, similar to system 100 of FIG. 1, configured to support a number of users, in which the teachings herein may be implemented. The system 200 provides communication for multiple cells 202, such as, for example, macro cells 202A-202G, with each cell being serviced by a corresponding access point 204 (e.g., access points 204A-204G). As shown in FIG. 2, access terminals 206 (e.g., access terminals 206A-206M) may be dispersed at various locations throughout the system over time. Each access terminal 206 may communicate with one or more access points 204 on a forward link (“FL”) and/or a reverse link (“RL) at a given moment, depending upon, for example, whether the access terminal 206 is active and whether it is in soft handoff. The wireless communication system 200 may provide service over a large geographic region. For example, macro cells 202A-202G may cover a few blocks in a neighborhood or several square miles in rural environment.

The described aspects may be implemented, for example, in macro cell 202D, where mobile station 206D may be handed-in from macro access point 204D to one of femto APs 206J and 206M, each sharing common identification information thereby making the identification of the hand-in target ambiguous.

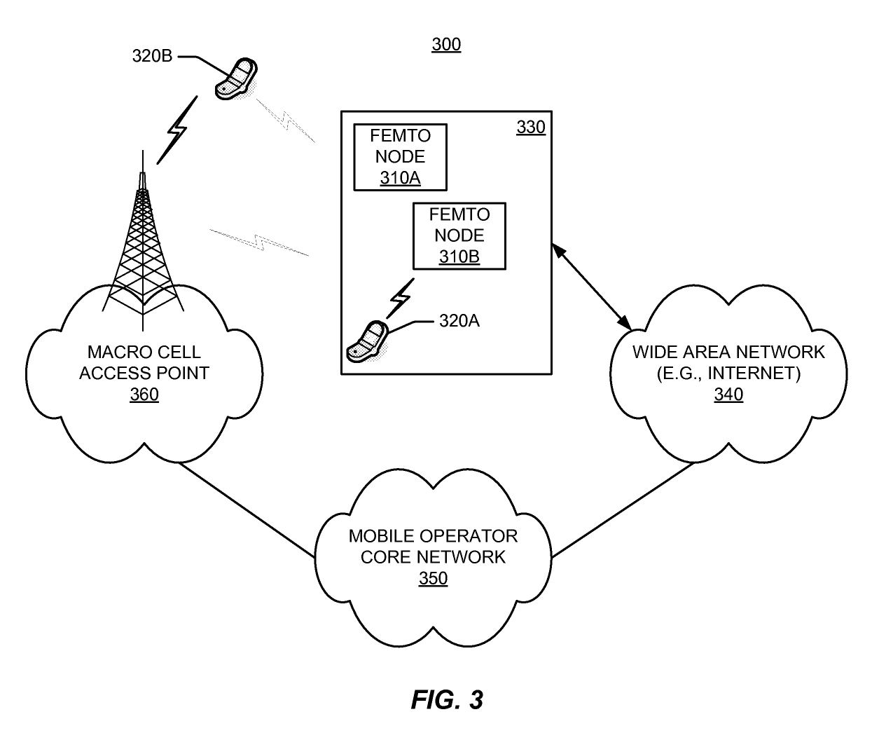

FIG. 3 illustrates an exemplary communication system 300, similar to systems 100 and 200, where one or more femto nodes are deployed within a network environment. Specifically, the system 300 includes multiple femto nodes 310 (e.g., femto nodes 310A and 310B) installed in a relatively small coverage network environment (e.g., in one or more user residences 330). Each femto node 310 may be coupled to a wide area network 340 (e.g., the Internet) and a mobile operator core network 350 via a DSL router, a cable modem, a wireless link, or other connectivity means (not shown).

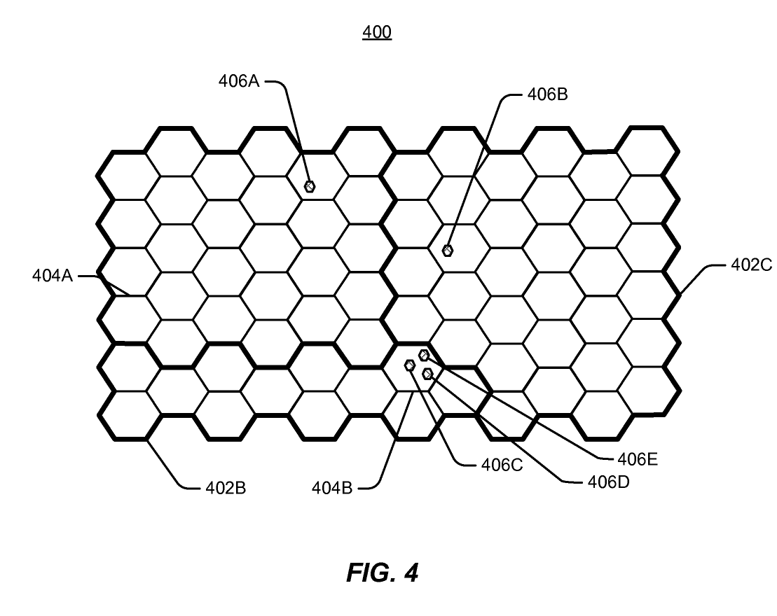

The owner of a femto node 310 may subscribe to mobile service, such as, for example, 3G or 4G mobile service, offered through the mobile operator core network 350. In addition, an access terminal 320 may be capable of operating both in macro environments and in smaller coverage (e.g., residential) network environments. In other words, depending on the current location of the access terminal 320, the access terminal 320 may be served by a macro cell access point 360 associated with the mobile operator core network 350 or by any one of a set of femto nodes 310 (e.g., the femto nodes 310A and 310B that reside within a corresponding user residence 330). For example, when a subscriber is outside his home, he may be served by a standard macro access point (e.g., access point 360) and when the subscriber is near or inside his home, he may be served by a femto node (e.g., node 310A). Here, a femto node 310 may be backward compatible with legacy access terminals 320. The relative coverage areas are described in more detail in FIG. 4.

FIG. 4 illustrates an example of a coverage map 400 where several tracking areas 402 (or routing areas or location areas) are defined, each of which includes several macro coverage areas 404. Areas of coverage associated with tracking areas 402A, 402B, and 402C are delineated by the bold lines, and the macro coverage areas 404 are represented by the hexagons within the tracking areas. The tracking areas 402 and the macro coverage areas 404 may also include one or more femto coverage areas 406. In this example, each of the femto coverage areas 406 (e.g., femto coverage area 406C) is depicted within a macro coverage area 404 (e.g., macro coverage area 404B). It should be appreciated, however, that a femto coverage area 406 may not lie entirely within a macro coverage area 404. Also, one or more pico coverage areas (not shown) may be defined within a given tracking area 402 or macro coverage area 404.

In practice, a large number of femto coverage areas 406, such as femto coverage areas 406C-E may be defined within a given tracking area 402 or macro coverage area 404. Consequently, when a mobile station (e.g. mobile station 104 in FIG. 1) detects a signal in such a network, the teachings herein may be employed to effectively identify which access point (e.g., which femto node) transmitted that signal. Once this access point is identified, the access terminal may be handed-off to that access point, if desired. Thus, effective techniques for providing handoffs between communication nodes are thus disclosed herein.

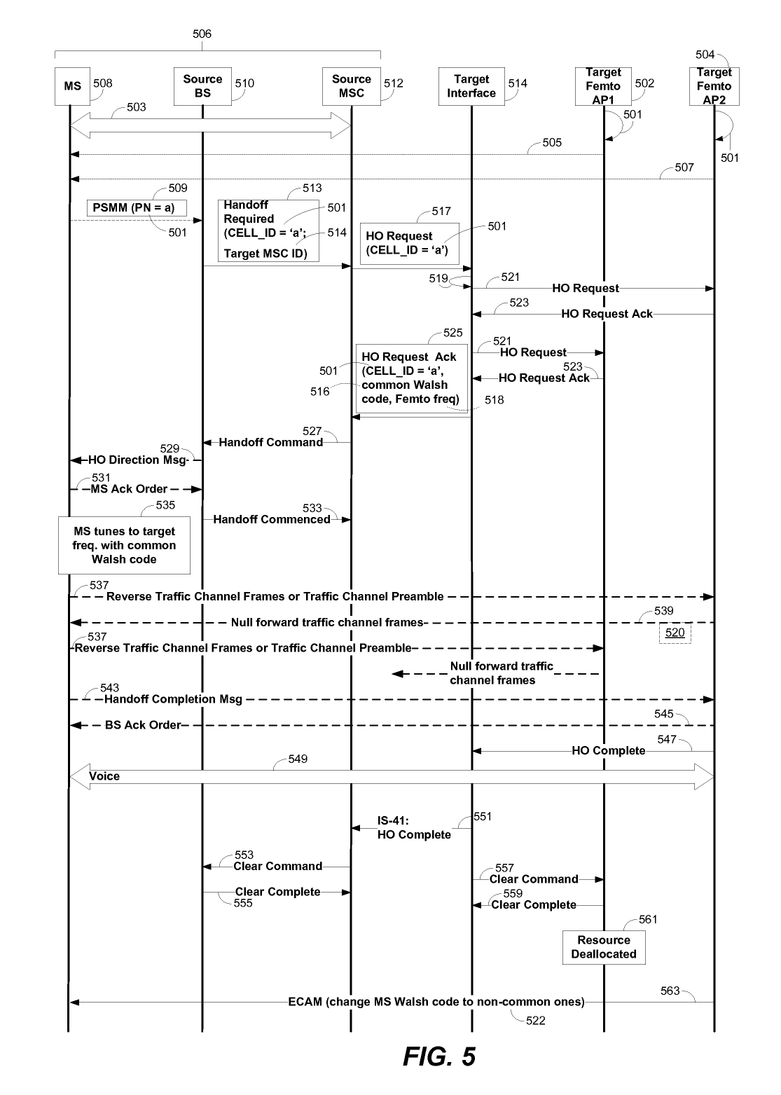

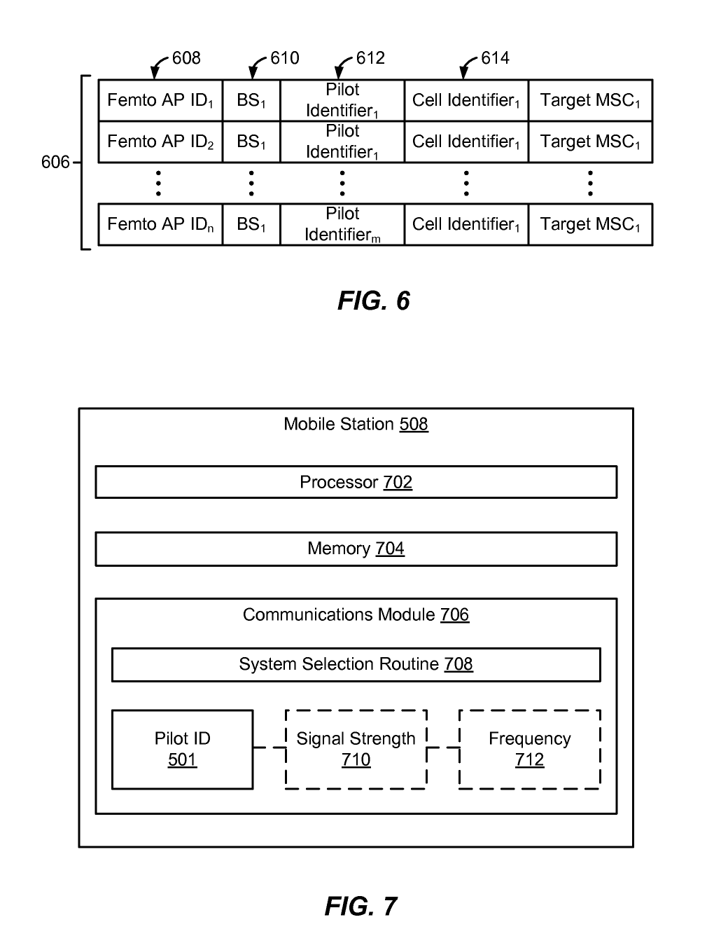

Referring to FIGS. 5-11, apparatus and methods of communication including efficient handoff, also referred to as hand-in, of a call from a macro node to a femto AP include a plurality of femto APs, such as target femto AP 502 and 504 (FIG. 5), located in the coverage area of a source macro network 506 wherein the identification of the target femto AP into which the call is to be handed-in is ambiguous. For example, source macro network 506 may have many potential target femto APs and only a limited number of pilot or AP identifiers, such that at least one identifier is shared or common to more than one potential target femto AP. For instance, referring to FIG. 6, one or more components within source wireless network 506 may determine or have access to all or portions of a mapping 606 relating a femto AP identifier 608, such as identifiers 1 to n, where n is a positive integer, that identifies each femto AP in the coverage area of a given base station 610 to a corresponding pilot identifier 612, such as identifiers 1 to m, where m is a positive integer less than n. As m is less than n, at least two femto AP identifiers 608 have the same pilot identifier 612 in the coverage area of the same base station 610, as illustrated in FIG. 6 by two femtos, Femto AP ID₁ and Femto AP ID₂, both having the same pilot identifier, Pilot Identifier₁. Moreover, mapping 606 may further relate each pilot identifier 612 to a corresponding cell identifier 614, which may further correspond to a target mobile switching center 616. Such mappings will be used for routing messages, as is discussed below. It is noted that although FIG. 6 only includes mappings of femto access points, source network 506 may maintain mappings of all access points (e.g. femto base stations, macro network base stations, etc.) within a given cell.

In one case, source macro network 506 may be a CDMA technology network having only a few available pilot identifiers, which in this case may be a pseudonoise (PN) code or PN offset, such that target femto AP 502 and 504 have the same PN code or PN offset. It should be understood, however, that the apparatus and methods described herein may apply as well to other network technologies having a similar problem of the same pilot identifiers shared by more than one target AP, thereby leading to ambiguity in identifying a target access point to receive a hand-in.

In any case, in the example of FIG. 5, target femto APs 502 and 504 obtain the same, or share a common, pilot identifier 501. For example, the pilot identifier 501 may be assigned by source macro network 506, or an operator of such network.

In an aspect, after mobile station 508 establishes a call 503 with source macro network 506, such as via source base station (BS) 510 and source mobile switching center (MSC) 512, mobile station 508 receives at least one pilot signal 505 and/or 507 respectively from target femto APs 502 and/or 504. For example, referring to FIG. 7, mobile station 508 may include a processor 702 and a memory 704, wherein processor 702 is operable to execute a communications module 706 for performing call establishment and handoff. For instance, in this aspect, communications module 706 may be performing a system selection routine 708 to detect pilot signals of other access points that may then be evaluated for use in a call handoff. For example, communications module 706 may include a transmitter and a receiver, or multiple transmitters and receivers, capable of communication with both macro networks and femto networks, and operable to receive and interpret the incoming messages discussed herein, and generate and transmit the respective outgoing messages discussed herein. In this case, communications module 706 may further tune to femto network frequencies to receive pilot signal 505 and/or 507, and communications module 706 may then determine pilot identifier 501 associated with the received pilot signal, wherein in this case pilot identifier 501 is common to at least one other target femto AP. Optionally, in some aspects, communications module 706 may additionally determine a signal strength 710 of the pilot signal measured by mobile station 508, and/or a frequency 712 of the pilot signal.

Returning to FIG. 5, mobile station 508 then transmits a measurement message 509 to source macro network 506, such as a pilot strength measurement message (PSMM) to source BS 510, wherein message 509 includes the determined pilot identifier 501 of the target femto AP corresponding to the received pilot signal. Optionally, in some aspects, measurement message 509 may additionally include a signal strength 710 (FIG. 7) of the pilot signal measured by mobile station 508, and/or a frequency 712 (FIG. 7) of the pilot signal, which may be utilized to determine which AP should receive the handoff when there is more than one option.

Mobile station 508 and/or source macro network 506 may determine, such as via operation of respective communication modules based on a received pilot signal 505 and/or 507 or measurement message 509, that a hand-in of call 503 to the target femto AP associated with AP identifier 501 is desired, and a handoff required message 513 is generated to effect the handoff. The handoff required message 513 includes a cell identifier 511 that corresponds to the pilot identifier 501 of the pilot signal, e.g. 505 and/or 507, received by the mobile station 508 and included in measurement message 509. Further, the handoff required message 513 may include a target mobile switching center, or target interface, identifier (target MSC ID) 514 that identifies the target interface corresponding to the cell identifier 511. As such, the handoff required message 513 is transmitted from the source BS 510 to the source mobile switching center (MSC) 512.

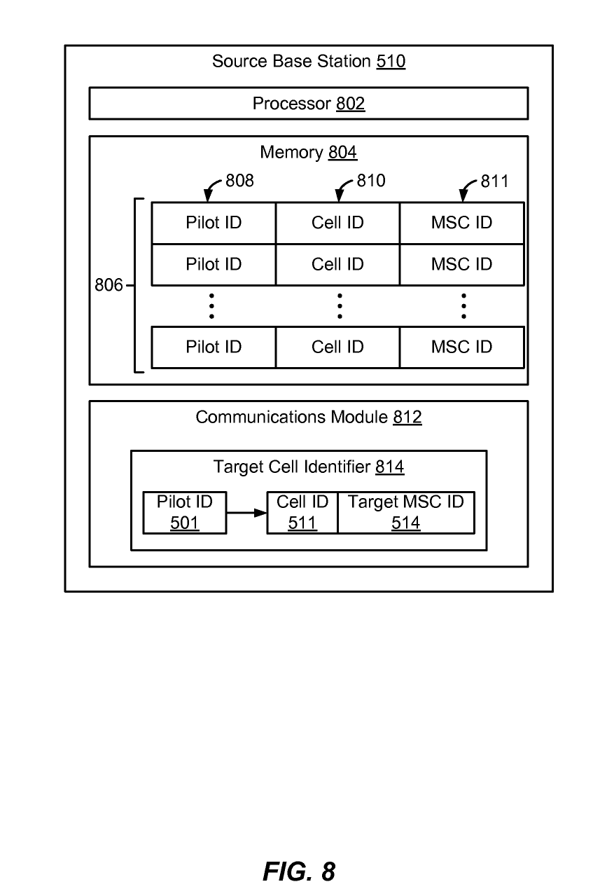

For example, in one aspect referring to FIG. 8, source BS 510 includes a processor 802 and a memory 804 that includes a mapping 806 relating pilot identifiers 808, such pilot ID 501 and including PN codes or PN offsets, to cell identifiers 810 and/or mobile switching center (MSC) identifiers 511. Further, source BS 510 includes a communications module 512 having one or more transmitters and receivers operable to communicate with mobile station 508 as well as source MSC 512, and operable to receive and interpret the incoming messages discussed herein, and generate and transmit the respective outgoing messages discussed herein. Additionally, source BS 510 may include a target cell identifier component 814 operable to determine a cell identifier 511, and the associated MSC ID 514, corresponding to pilot identifier 501. Also, for example, communications module 512 is further operable to generate handoff required message 513 that includes the determined cell identifier 511 and target MSC ID 514 and forward the handoff required message 513 to the source MSC 512.

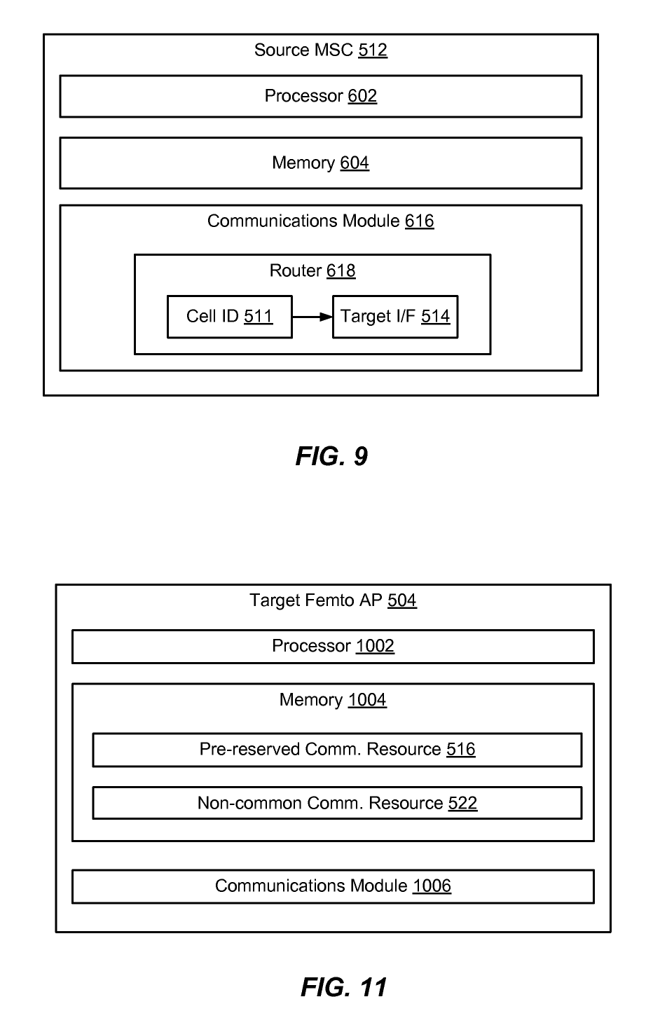

In an aspect, source MSC 512 receives the handoff required message 513, and determines 515 a target interface 514, such as a target MSC, corresponding to the cell identifier 511. For example, referring to FIG. 9, source MSC 512 may have a processor 602 for executing instructions, a memory 604 for storing instructions and data, and a communications module 616 having a transmitter and receiver operable to communicate with source BS 510 and one or more target interfaces or MSCs 614. Communications module 616 may receive and interpret the incoming messages discussed herein, and in combination with processor 602 generate and transmit the respective outgoing messages discussed herein. Further, communication module 616 may include a router 618 operable to forward the handoff request to the target MSC identified in handoff request 513.

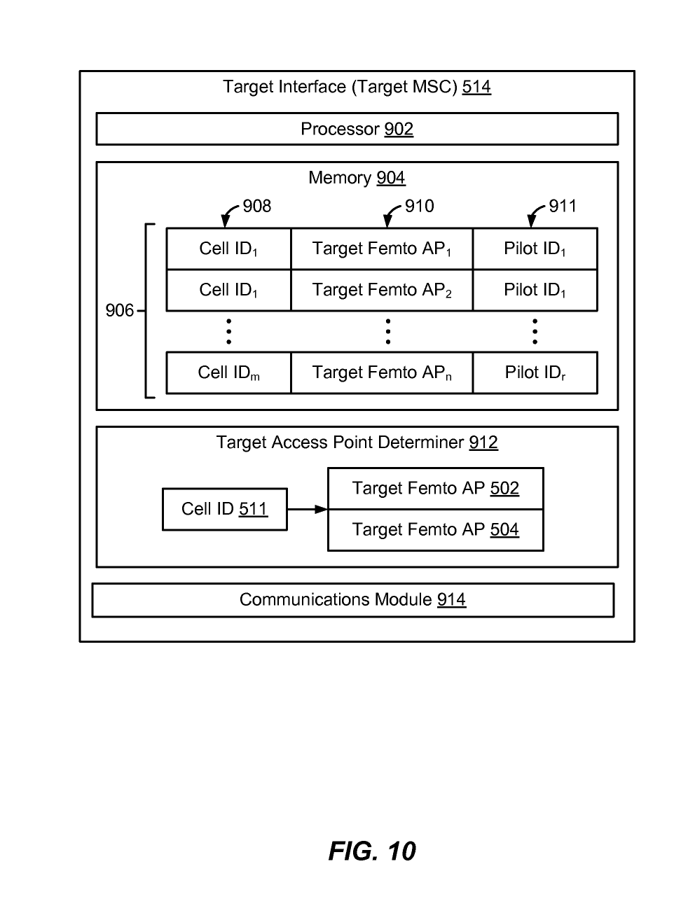

Then, returning to FIG. 5, source MSC 512 transmits a handoff request message 517, including cell identifier 511, to the identified target interface 514, which at 519 then determines candidate target femto APs based on cell identifier 511. For example, referring to FIG. 10, target interface 514 includes a processor 902 and a memory 904 including a mapping 906 of a relationship between a plurality of cell identifiers 908 and corresponding ones of a plurality of target femto APs 910 and pilot IDs 911. In other words, in these aspects, the femto base stations that share the same pilot identifier are also associated with the same cell identifier. Further, target interface 514 may include a candidate target access point determiner 912 operable to receive handoff request message 517, detect cell identifier 511, consult mapping 906 to determine a match between cell identifier 511 and one of the plurality of cell identifiers 908, and then determine the corresponding one or more of the plurality of target femto APs 910. For example, in some aspects, the determined one or more target femto APs may comprise a subset of the plurality of access points known to the target interface 514. In this case, cell identifier 511 corresponds to more than one target femto AP, such as target femto APs 502 and 504, due to the same identifier being assigned to a plurality of femto APs. As such, in the target system, the exact identity of the AP to which the call is to be handed-in is ambiguous because of the use of common identifiers.

In any case, returning to FIG. 5, target interface 514 then sends a handoff request message 521 to all of the identified target femto APs, such as target femto APs 502 and 504 in this case. In other words, the target interface 514 forwards the handoff request message 521 to all femto access points that map to the cell ID 511 received in the handoff request 517. For example, referring to FIG. 9, target interface 514 further includes a communications module 914 having one or more transmitters and receivers to enable communication with source network 506, such as with source MSC 512, and with target femto APs, such as target femto APs 502 and 504. Also, communications module 914 may receive and interpret the incoming messages discussed herein, and generate and transmit the respective outgoing messages discussed herein. For example, communications module 914 is operable to generate and transmit handoff request message 521 in response to receiving handoff request message 517 and based on the operation of target AP determiner 912 in identifying potential candidate target femto APs to which a call may be handed off.

Returning to FIG. 5, in response to handoff request message 521, target interface 514 receives a handoff request acknowledgement message 523 from one or more of the identified target femto APs, such as target femto APs 502 and 504 in this case. For example, referring to FIG. 11, target femto APs 502 and 504 include a processor 1002 and a memory 1004 that includes pre-reserved communication resource 516, which is shared by a plurality of target femto APs, as well as one or more non-common resources 522, which will be discussed in more detail below Further, target femto APs 502 and 504 also include a communications module 1004 operable to receive and interpret the incoming messages discussed herein, and generate and transmit the respective outgoing messages discussed herein. Please note that for purposes of example, FIG. 11 identifies target femto AP 504, but target femto AP 502 is similar. As such, communications module 1004 of the respective target femto AP sends handoff request acknowledgement 523 in response to receiving handoff request 521.

Based on receipt of at least one handoff request acknowledgement message 523, referring to FIG. 5, target interface 514 transmits a handoff request acknowledgement message 525 to source macro network 506, such as to source MSC 512. For example, referring to FIG. 10, communications module 914 may receive handoff request acknowledgement message 523, and in response generate and transmit handoff request acknowledgement message 525 back to the source MSC 512 that initially sent handoff request message 521. Handoff request acknowledgement message 525 includes a pre-reserved communication resource 516, which is common to the plurality of target femto APs associated with the same pilot identifier 501 or cell identifier 511, which enables a mobile station to communicate with any of the plurality of target femto APs associated with the same pilot identifier 501 or cell identifier 511. For example, pre-reserved communication resource 516 may be a code defining a target communication channel designated for the mobile station with the target APs, such as a common Walsh code in a CDMA technology system. Optionally, handoff request acknowledgement message 525 may additionally include cell identifier 511 and/or a frequency 518 to use for the communication. Further, for example, pre-reserved communication resource 516 may be stored at target interface 514, such as in memory 904, target access point determiner 912, or communications module 914. Referring to FIG. 5, the instruction to handoff the call may then be communicated to the mobile station 508, along with at least the pre-reserved communication resource 516, such as via a handoff command 527 sent from source MSC 512 to source BS 510, and a handoff direction message 529 sent from source BS 510 to mobile station 508.

Mobile station 504 may acknowledge the instructions to handoff the call, such as by sending an acknowledgement order message 531 to source BS 510, which may in turn provide confirmation to source MSC 512, such as via a handoff commenced message 533.

At 535, mobile station 508 tunes to the communication channel, such as via operation of communications module 706 (FIG. 7), and transmits traffic data 537, e.g. voice frames, according to the pre-reserved resource. For example, in an aspect, traffic data 537 may be a reverse traffic channel frame or traffic channel preamble. It should be noted that FIG. 5 includes two separate transmissions of traffic data 537, however, mobile station 508 may send a single transmission of traffic data 537 over a communication channel corresponding to pre-reserved communication resource 516, and as such this single message may be received by each of the plurality of target femto APs sharing the same pilot identifier, and hence the same pre-reserved communication resource 516, e.g. target femto APs 502 and 504. As such, two separate messages 537 are included to represent the separate receipt of the message by different target femto APs.

In response to handoff request 521, each target femto AP (or at least the femto APs that send acknowledgements 523) begins to transmit traffic data, such as traffic data 539 from target femto AP 504 and traffic data 541 from target femto AP 502, to enable the mobile station 508 to detect the assigned channel, corresponding to the pre-reserved resource, from the target access point and thereby acquire the channel. For example, traffic data 539 may be one or more null forward traffic channel frames. Due to the location of mobile station 508 and the respective forward link coverage area (e.g., such as area 120, 122 or 124 of FIG. 1) of target femto APs 502 and 504, mobile station 508 may receive only receive traffic data 539 corresponding to target femto AP 504 having a forward link coverage area in which mobile station 508 is located. In this case, traffic data 541 never reaches mobile station 508 as mobile station 508 is outside of the forward link coverage area of target femto AP 502. As such, the ambiguity with regard to the exact identity of the target femto AP which is to receive the hand-in of the call is resolved based on the proximity between the mobile station and the target femto AP. In some cases, the described aspects may be performed when there is no PN collision, e.g. two or more target femto APs with the same PN code or offset and overlapping forward link coverage areas, in the location of the mobile station such that the mobile station in such cases receives a response message from a single target femto AP corresponding to the respective PN code or offset. In any case, target femto AP 504 may be the closest femto AP to the mobile station, or the closest target femto AP having a PN code or offset that does not collide with another target femto AP. Accordingly, based on receiving forward link traffic data 539, mobile station 508 transmits a handoff complete message 543 to target femto AP 504, which responds with an acknowledgement message 545, such as a base station (BS) acknowledgement order, and further transmits a handoff complete message 547 to notify target interface 514 of the completion of the requested handoff. Thus, target interface 514 begins forwarding data frames corresponding to the call to target femto AP 504.

Optionally, for example, traffic data 539 may include a power-control command 520 instructing mobile station 508 to reduce the reverse link transmit power based on the proximity between mobile station 508 and target femto AP 504. Such a power-control command 520 may result in a reverse link transmission from mobile station 508 being able to cover a distance to target femto AP 504, and as such in some cases the reverse link coverage of the mobile station may be about equal to or may be less than the forward link coverage of target femto AP 504. As such, in this case, handoff completion message 543 may be power-controlled such that it only reaches target femto AP 504, which may be the closest femto AP to the mobile station, or the closest target femto AP 504 having a PN code or offset that does not collide with another target femto AP. In other words, based on proximity of mobile station 508 to the target femto access points, handoff completion message 543 may only be received by one target femto access point.

Thus, at 549, the call is handed off such that femto AP 504 carries the call for mobile station 504, and a series of subsequent network-side messages/actions are initiated to account for the handoff. For example, the subsequent network-side messages/actions may include a handoff complete message 551 transmitted from target interface 514 to source MSC 512. The source network then clears the resources associated with call 503, such as via a clear command 553 and a clear complete 555 transmitted between source MSC 512 and source BS 510. Similarly, the target network clears any resources allocated by the non-selected target femto APs, such as via a clear command 557 and a clear complete 559 transmitted between target interface 514 and target femto AP 502.

Additionally, in some optional aspects, subsequent to the handoff, target femto AP 504 that is now carrying the call may transmit an assignment message 563, including a new communication resource 522, to mobile station 508 to re-assign the call to utilize a more unique communication channel associated with target femto AP 504. In other word, once the hand-in occurs, new communication resource 522 changes the communications between mobile station 508 and the presently-serving femto access point to a more unique setting, thereby switching away from the common resource that is utilized to effect hand-in to an ambiguous target femto access point. Thus, mobile station 508 is able to reduce the chance of interference in communications by switching from common pre-reserved communication resource 516 to a non-common communication resource 522 associated more specifically with target femto AP 504 carrying the call.

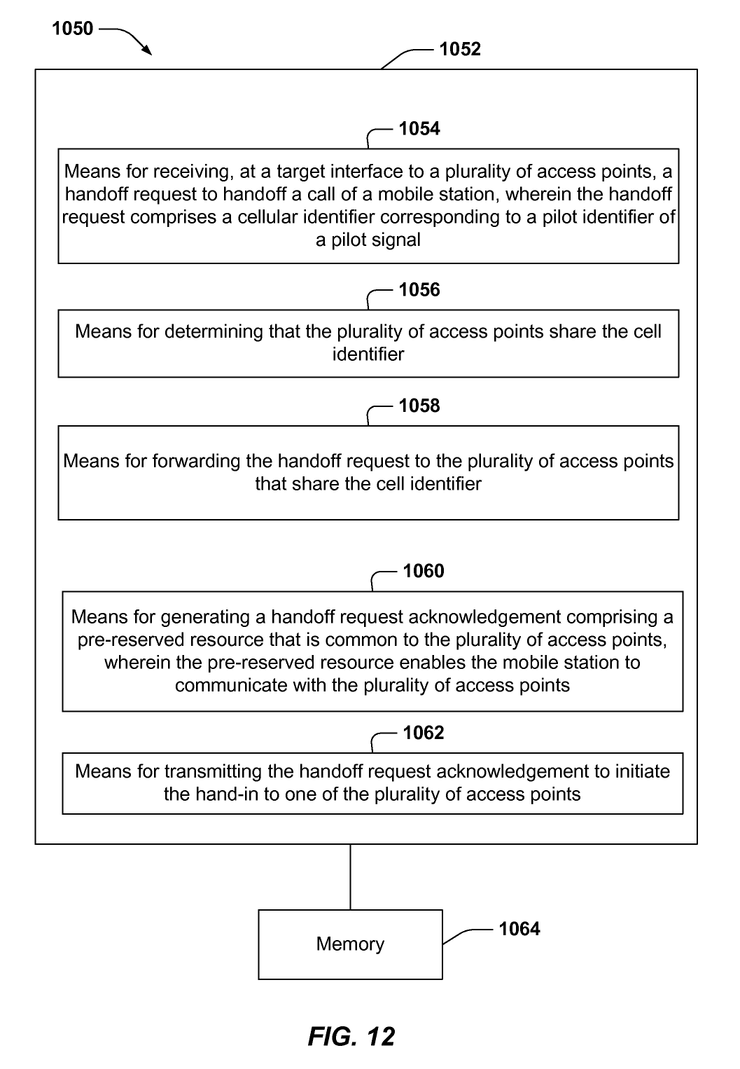

Referring to FIG. 12, in another aspect, a system 1050 for communication is operable to enable hand-in of a call from a macro network to a target femto access point. For example, system 1050 can reside at least partially within a target network interface, such as a target MSC of a femto network. It is to be appreciated that system 1050 is represented as including functional blocks, which can be functional blocks that represent functions implemented by a processor, software, or combination thereof (e.g., firmware). System 1050 includes a logical grouping 1052 of electrical components that can act in conjunction. For instance, logical grouping 1052 can include a means for receiving, at a target interface to a plurality of access points, a handoff request to handoff a call of a mobile station, wherein the handoff request comprises a cellular identifier corresponding to a pilot identifier of a pilot signal 1054. Also, logical grouping 1052 can include a means for determining that the plurality of access points share the cell identifier 1056, and a means for forwarding the handoff request to the plurality of access points that share the cell identifier 1058. Further, logical grouping 1052 can include a means for generating a handoff request acknowledgement comprising a pre-reserved resource that is common to the plurality of access points, wherein the pre-reserved resource enables the mobile station to communicate with the plurality of access points 1060. Additionally, logical grouping 1052 can include a means for transmitting the handoff request acknowledgement to initiate the hand-in to one of the plurality of access points 1062.

Further, system 1050 can include a memory 1064 that retains instructions for executing functions associated with electrical components 1054, 1056, 1058, 1060 and 1062. While shown as being external to memory 1064, it is to be understood that one or more of electrical components 1054, 1056, 1058, 1060 and 1062 can exist within memory 1064.

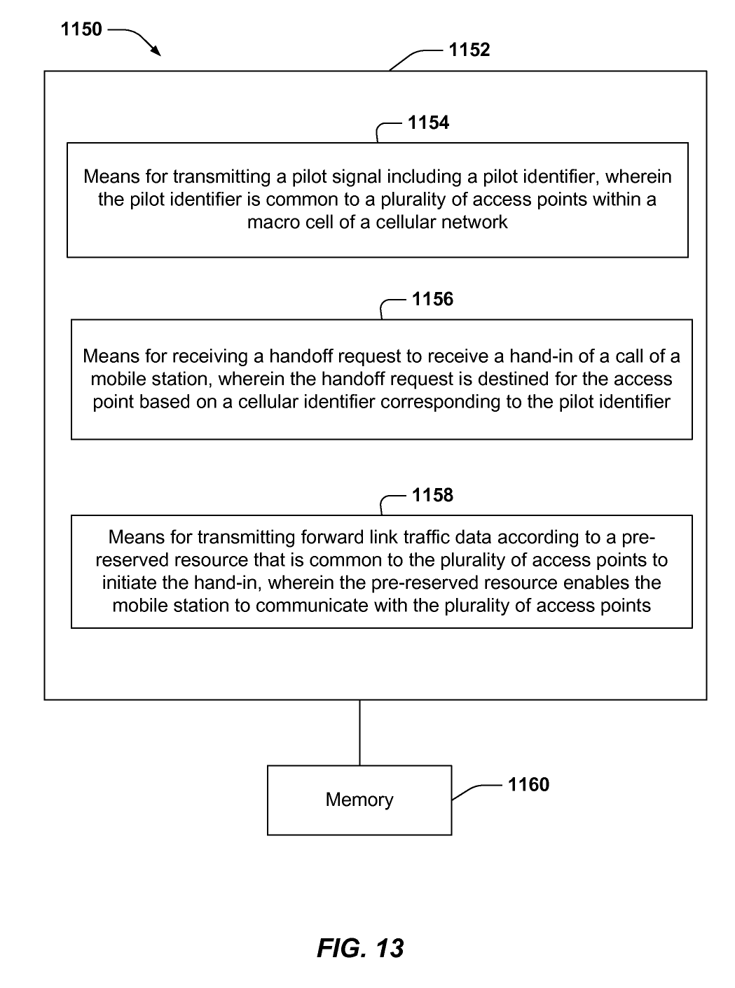

Referring to FIG. 13, in another aspect, a system 1150 for communication is operable to enable hand-in of a call from a macro network to a target femto access point. For example, system 1150 can reside at least partially within an access point, such as a target femto base station or a target femto access point. It is to be appreciated that system 1150 is represented as including functional blocks, which can be functional blocks that represent functions implemented by a processor, software, or combination thereof (e.g., firmware). System 1150 includes a logical grouping 1152 of electrical components that can act in conjunction. For instance, logical grouping 1152 can include a means for transmitting a pilot signal including a pilot identifier, wherein the pilot identifier is common to a plurality of access points within a macro cell of a cellular network 1154. Further, for example, logical grouping 1152 can include a means for receiving a handoff request to receive a hand-in of a call of a mobile station, wherein the handoff request is destined for the access point based on a cellular identifier corresponding to the pilot identifier 1156. Additionally, for example, logical grouping 1152 can include a means for transmitting forward link traffic data according to a pre-reserved resource that is common to the plurality of access points to initiate the hand-in, wherein the pre-reserved resource enables the mobile station to communicate with the plurality of access points 1158.

Further, system 1150 can include a memory 1160 that retains instructions for executing functions associated with electrical components 1154, 1156 and 1158. While shown as being external to memory 1164, it is to be understood that one or more of electrical components 1154, 1156 and 1158 can exist within memory 1160.

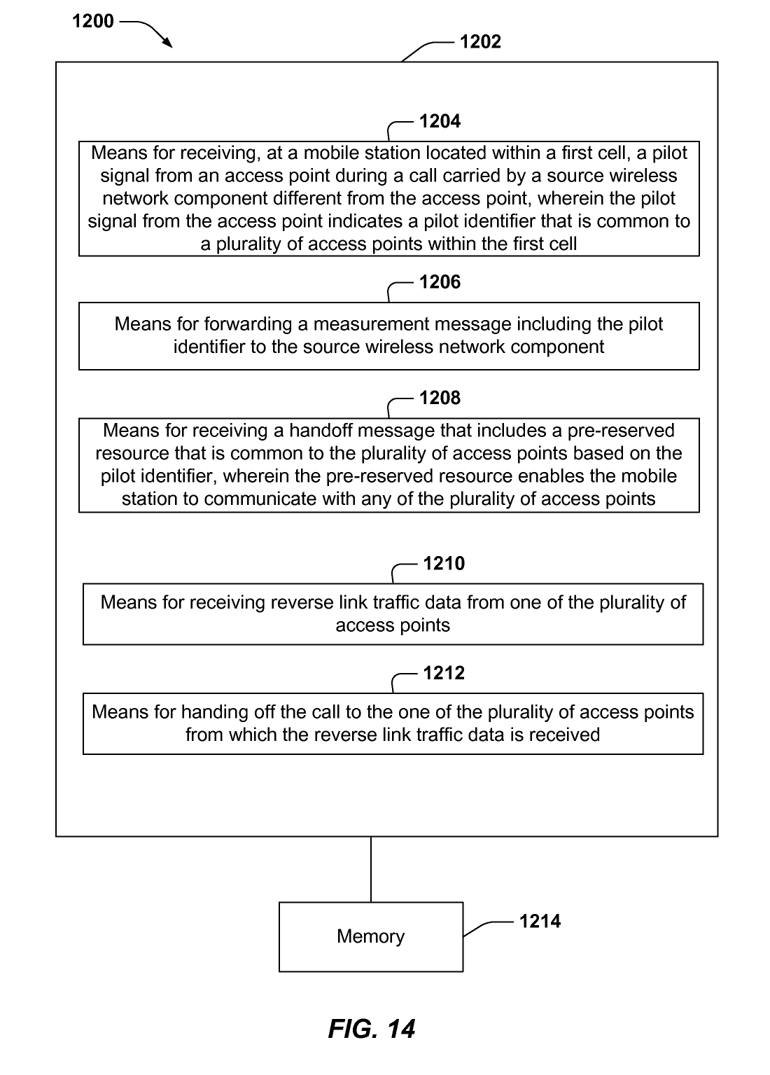

Referring to FIG. 14, in another aspect, a system 1200 for communication is operable to enable hand-in of a call from a macro network to a target femto access point. For example, system 1200 can reside at least partially within a transmitter, or a mobile station, etc. It is to be appreciated that system 1200 is represented as including functional blocks, which can be functional blocks that represent functions implemented by a processor, software, or combination thereof (e.g., firmware). System 1200 includes a logical grouping 1202 of electrical components that can act in conjunction. For instance, logical grouping 1202 can include a means for receiving, at a mobile station located within a first cell, a pilot signal from an access point during a call carried by a source wireless network component different from the access point, wherein the pilot signal from the access point indicates a pilot identifier that is common to a plurality of access points within the first cell 1204. Further, logical grouping 1202 can include a means for forwarding a measurement message to the source wireless network component including the pilot identifier 1206. Also, logical grouping 1202 can include a means for receiving a handoff message that includes a pre-reserved resource that is common to the plurality of access points based on the pilot identifier, wherein the pre-reserved resource enables the mobile station to communicate with any of the plurality of access points 1208. Logical grouping 1202 can further include a means for receiving forward link traffic data from one of the plurality of access points 1210. Additionally, logical grouping 1202 can further include a means for handing off the call to the one of the plurality of access points from which the forward link traffic data is received 1212.

Further, system 1200 can include a memory 1214 that retains instructions for executing functions associated with electrical components 1204, 1206, 1208, 1210 and 1212. While shown as being external to memory 1214, it is to be understood that one or more of electrical components 1204, 1206, 1208, 1210 and 1212 can exist within memory 1214.

It should be appreciated that the teachings herein may be implemented in various types of communication devices. In some aspects, the teachings herein may be implemented in wireless devices that may be deployed in multiple access communication system that may simultaneously support communication for multiple wireless access terminals. Here, each terminal may communicate with one or more access points via transmissions on the forward and reverse links. The forward link (or downlink) refers to the communication link from the access points to the terminals, and the reverse link (or uplink) refers to the communication link from the terminals to the access points. This communication link may be established via a single-in-single-out system, a multiple-in-multiple-out (“MIMO”) system, or some other type of system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (“TDD”) and frequency division duplex (“FDD”). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

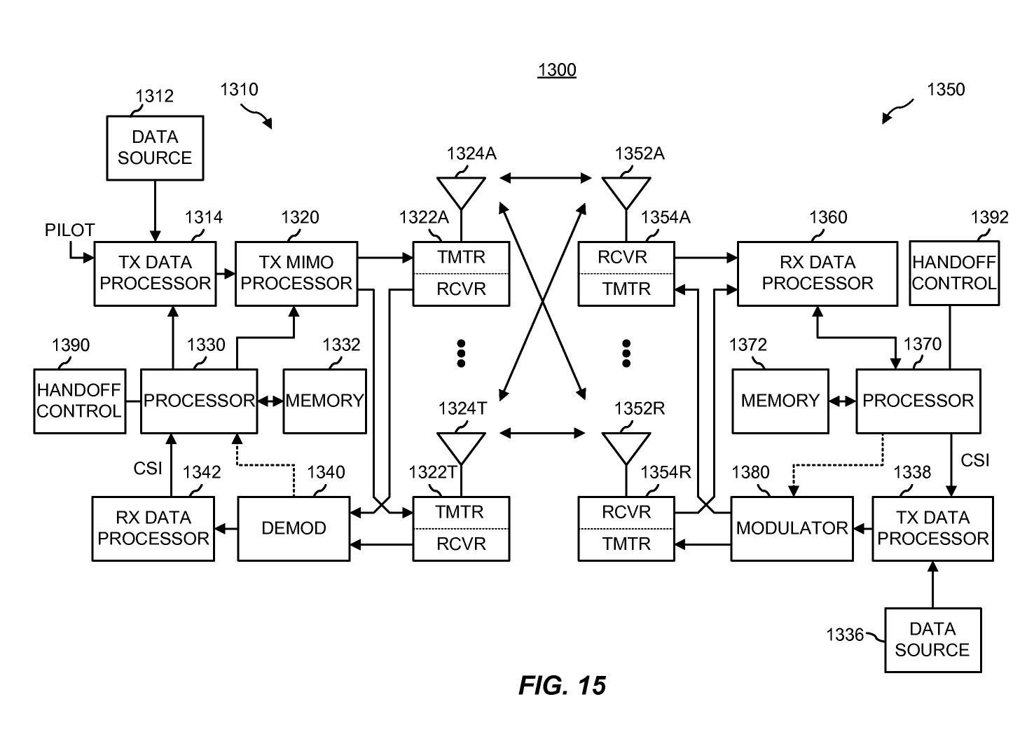

The teachings herein may be incorporated into a node (e.g., a device) employing various components for communicating with at least one other node. FIG. 15 depicts several sample components that may be employed to facilitate communication between nodes. Specifically, FIG. 15 illustrates a wireless device 1310 (e.g., an access point) and a wireless device 1350 (e.g., an access terminal) of a MIMO system 1300. At the device 1310, traffic data for a number of data streams is provided from a data source 1312 to a transmit (“TX”) data processor 1314.

In some aspects, each data stream is transmitted over a respective transmit antenna. The TX data processor 1314 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 1330. A data memory 1332 may store program code, data, and other information used by the processor 1330 or other components of the device 1310.

The modulation symbols for all data streams are then provided to a TX MIMO processor 1320, which may further process the modulation symbols (e.g., for OFDM). The TX MIMO processor 1320 then provides N_{T} modulation symbol streams to N_{T} transceivers (“XCVR”) 1322A through 1322T. In some aspects, the TX MIMO processor 1320 applies beam-forming weights to the symbols of the data streams and to the antenna from which the symbol is being transmitted.

Each transceiver 1322 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers 1322A through 1322T are then transmitted from N_{T} antennas 1324A through 1324T, respectively.

At the device 1350, the transmitted modulated signals are received by N_{R} antennas 1352A through 1352R and the received signal from each antenna 752 is provided to a respective transceiver (“XCVR”) 1354A through 1354R. Each transceiver 1354 conditions (e.g., filters, amplifies, and downconverts) a respective received signal, digitizes the conditioned signal to provide samples, and further processes the samples to provide a corresponding “received” symbol stream.

A receive (“RX”) data processor 1360 then receives and processes the N_{R} received symbol streams from N_{R} transceivers 1354 based on a particular receiver processing technique to provide N_{T} “detected” symbol streams. The RX data processor 1360 then demodulates, deinterleaves, and decodes each detected symbol stream to recover the traffic data for the data stream. The processing by the RX data processor 1360 is complementary to that performed by the TX MIMO processor 1320 and the TX data processor 1314 at the device 1310.

A processor 1370 periodically determines which pre-coding matrix to use (discussed below). The processor 1370 formulates a reverse link message comprising a matrix index portion and a rank value portion. A data memory 1372 may store program code, data, and other information used by the processor 1370 or other components of the device 1350.

The reverse link message may comprise various types of information regarding the communication link and/or the received data stream. The reverse link message is then processed by a TX data processor 1338, which also receives traffic data for a number of data streams from a data source 1336, modulated by a modulator 1380, conditioned by the transceivers 1354A through 1354R, and transmitted back to the device 1310.

At the device 1310, the modulated signals from the device 1350 are received by the antennas 1324, conditioned by the transceivers 1322, demodulated by a demodulator (“DEMOD”) 1340, and processed by a RX data processor 1342 to extract the reverse link message transmitted by the device 1350. The processor 1330 then determines which pre-coding matrix to use for determining the beam-forming weights then processes the extracted message.

FIG. 15 also illustrates that the communication components may include one or more components that perform handoff operations as taught herein. For example, a handoff control component 1390 may cooperate with the processor 1330 and/or other components of the device 1310 to send/receive handoff-related signals to/from another device (e.g., device 1350) as taught herein. Similarly, a handoff control component 1392 may cooperate with the processor 1370 and/or other components of the device 1350 to send/receive handoff-related signals to/from another device (e.g., device 1310). It should be appreciated that for each device 1310 and 1350 the functionality of two or more of the described components may be provided by a single component. For example, a single processing component may provide the functionality of the handoff control component 1390 and the processor 1330 and a single processing component may provide the functionality of the handoff control component 1392 and the processor 1370.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (“CDMA”) systems, Multiple-Carrier CDMA (“MCCDMA”), Wideband CDMA (“W-CDMA”), High-Speed Packet Access (“HSPA,” “HSPA+”) systems, Time Division Multiple Access (“TDMA”) systems, Frequency Division Multiple Access (“FDMA”) systems, Single-Carrier FDMA (“SC-FDMA”) systems, Orthogonal Frequency Division Multiple Access (“OFDMA”) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (“UTRA)”, cdma2000, or some other technology. UTRA includes W-CDMA and Low Chip Rate (“LCR”). The cdma2000 technology covers IS-2000, IS-95 and IS-856 standards. A TDMA network may implement a radio technology such as Global System for Mobile Communications (“GSM”). An OFDMA network may implement a radio technology such as Evolved UTRA (“E-UTRA”), IEEE 802.11, IEEE 802.16, IEEE 802.20, Flash-OFDM®, etc. UTRA, E-UTRA, and GSM are part of Universal Mobile Telecommunication System (“UMTS”). The teachings herein may be implemented in a 3GPP Long Term Evolution (“LTE”) system, an Ultra-Mobile Broadband (“UMB”) system, and other types of systems. LTE is a release of UMTS that uses E-UTRA. Although certain aspects of the disclosure may be described using 3GPP terminology, it is to be understood that the teachings herein may be applied to 3GPP (Re199, Re15, Re16, Re17) technology, as well as 3GPP2 (IxRTT, 1xEV-DO RelO, RevA, RevB) technology and other technologies. These various radio technologies and standards are known in the art. For clarity, certain aspects of the techniques are described for LTE, and LTE terminology may be used in the description.

Single carrier frequency division multiple access (SC-FDMA), which utilizes single carrier modulation and frequency domain equalization, is a technique that also may be utilized with the described aspects. SC-FDMA has similar performance and essentially the same overall complexity as those of OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for uplink multiple access scheme in 3GPP Long Term Evolution (LTE), or Evolved UTRA.

The teachings herein may be incorporated into (e.g., implemented within or performed by) a variety of apparatuses (e.g., nodes). In some aspects, a node (e.g., a wireless node) implemented in accordance with the teachings herein may comprise an access point or an access terminal.

For example, an access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations an access terminal may comprise a cellular telephone, a cordless telephone, a session initiation protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a NodeB, an eNodeB, a radio network controller (“RNC”), a base station (“BS”), a radio base station (“RBS”), a base station controller (“BSC”), a base transceiver station (“BTS”), a transceiver function (“TF”), a radio transceiver, a radio router, a basic service set (“BSS”), an extended service set (“ESS”), or some other similar terminology.

In some aspects a node (e.g., an access point) may comprise an access node for a communication system. Such an access node may provide, for example, connectivity for or to a network (e.g., a wide area network such as the Internet or a cellular network) via a wired or wireless communication link to the network. Accordingly, an access node may enable another node (e.g., an access terminal) to access a network or some other functionality. In addition, it should be appreciated that one or both of the nodes may be portable or, in some cases, relatively non-portable.

Also, it should be appreciated that a wireless node may be capable of transmitting and/or receiving information in a non-wireless manner (e.g., via a wired connection). Thus, a receiver and a transmitter as discussed herein may include appropriate communication interface components (e.g., electrical or optical interface components) to communicate via a non-wireless medium.

A wireless node may communicate via one or more wireless communication links that are based on or otherwise support any suitable wireless communication technology. For example, in some aspects a wireless node may associate with a network. In some aspects the network may comprise a local area network or a wide area network. A wireless device may support or otherwise use one or more of a variety of wireless communication technologies, protocols, or standards such as those discussed herein (e.g., CDMA, TDMA, OFDM, OFDMA, WiMAX, Wi-Fi, and so on). Similarly, a wireless node may support or otherwise use one or more of a variety of corresponding modulation or multiplexing schemes. A wireless node may thus include appropriate components (e.g., air interfaces) to establish and communicate via one or more wireless communication links using the above or other wireless communication technologies. For example, a wireless node may comprise a wireless transceiver with associated transmitter and receiver components that may include various components (e.g., signal generators and signal processors) that facilitate communication over a wireless medium.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Further, for example, any processor described herein, such as processors 602, 702, 802, 902, and 1002, are operable to execute instructions, computer readable media or code to initiate or perform the functions of any components associated with the respective processor.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. In summary, it should be appreciated that a computer-readable medium may be implemented in any suitable computer-program product.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. A method of performing a hand-in, comprising:
receiving, at a target interface to a plurality of access points, a handoff request to handoff a call of a mobile station, wherein the handoff request comprises a cellular identifier corresponding to a pilot identifier of a pilot signal;
determining that the plurality of access points share the cell identifier;
forwarding the handoff request to the plurality of access points that share the cell identifier;
generating a handoff request acknowledgement comprising a pre-reserved resource that is common to the plurality of access points, wherein the pre-reserved resource enables the mobile station to communicate with the plurality of access points; and
transmitting the handoff request acknowledgement to initiate the hand-in to one of the plurality of access points.

2. The method of claim 1, wherein generating the handoff request further comprising including a common frequency for the mobile station to use to communicate with any of the plurality of access points.

3. The method of claim 1, wherein generating the pre-reserved resource further comprises including a communication code defining a unique communication channel for use by the mobile station.

4. The method of claim 3, wherein the cellular identifier corresponds to a pilot identifier comprising a pseudonoise code or pseudonoise offset that is common to each of the plurality of access points, and wherein including the communication code further comprises including a Walsh code.

5. The method of claim 1, wherein the plurality of access points comprise one of a plurality a femto access points each having at least a portion of a respective coverage area within a first cell of a cellular network carrying the call, wherein the plurality of femto access points is greater than a number of available pilot identifiers for use in the first cell, and wherein the plurality of access points comprises a subset of the plurality of femto access points.

6. The method of claim 1, wherein generating the handoff request acknowledgement is based on receiving at least one access point-generated handoff request acknowledgement in response to the handoff request forwarded to the plurality of access points.

7. At least one processor for performing a hand-in, comprising:
a first module for receiving, at a target interface to a plurality of access points, a handoff request to handoff a call of a mobile station, wherein the handoff request comprises a cellular identifier corresponding to a pilot identifier of a pilot signal;
a second module for determining that the plurality of access points share the cell identifier;
a third module for forwarding the handoff request to the plurality of access points that share the cell identifier;
a fourth module for generating a handoff request acknowledgement comprising a pre-reserved resource that is common to the plurality of access points, wherein the pre-reserved resource enables the mobile station to communicate with the plurality of access points; and
a fifth module for transmitting the handoff request acknowledgement to initiate the hand-in to one of the plurality of access points.

8. The at least one processor of claim 7, wherein the fourth module for generating the pre-reserved resource further comprises including a Walsh code defining a unique communication channel for use by the mobile station, and wherein the cellular identifier corresponds to a pilot identifier comprising a pseudonoise code or pseudonoise offset that is common to each of the plurality of access points.

9. The at least one processor of claim 7, wherein the plurality of access points each comprise one of a plurality a femto access points each having at least a portion of a respective coverage area within a first cell of a cellular network carrying the call, wherein the plurality of femto access points is greater than a number of available pilot identifiers for use in the first cell, and wherein the plurality of access points comprises a subset of the plurality of femto access points.

10. A computer program product for performing a hand-in, comprising:
a computer-readable medium, comprising:
at least one instruction operable to cause a computer to receive, at a target interface to a plurality of access points, a handoff request to handoff a call of a mobile station, wherein the handoff request comprises a cellular identifier corresponding to a pilot identifier of a pilot signal;
at least one instruction operable to cause the computer to determine that the plurality of access points share the cell identifier;
at least one instruction operable to cause the computer to forward the handoff request to the plurality of access points that share the cell identifier;
at least one instruction operable to cause the computer to generate a handoff request acknowledgement comprising a pre-reserved resource that is common to the plurality of access points, wherein the pre-reserved resource enables the mobile station to communicate with the plurality of access points; and
at least one instruction operable to cause the computer to transmit the handoff request acknowledgement to initiate the hand-in to one of the plurality of access points.

11. The product of claim 10, wherein the pre-reserved resource further comprises a Walsh code defining a unique communication channel for use by the mobile station, and wherein the cellular identifier corresponds to a pilot identifier comprising a pseudonoise code or pseudonoise offset that is common to each of the plurality of access points.

12. The product of claim 10, wherein the plurality of access points each comprise one of a plurality a femto access points each having at least a portion of a respective coverage area within a first cell of a cellular network carrying the call, wherein the plurality of femto access points is greater than a number of available pilot identifiers for use in the first cell, and wherein the plurality of access points comprises a subset of the plurality of femto access points.

13. A target interface component for performing a hand-in, comprising:
means for receiving, at a target interface to a plurality of access points, a handoff request to handoff a call of a mobile station, wherein the handoff request comprises a cellular identifier corresponding to a pilot identifier of a pilot signal;
means for determining that the plurality of access points share the cell identifier;
means for forwarding the handoff request to the plurality of access points that share the cell identifier;
means for generating a handoff request acknowledgement comprising a pre-reserved resource that is common to the plurality of access points, wherein the pre-reserved resource enables the mobile station to communicate with the plurality of access points; and
means for transmitting the handoff request acknowledgement to initiate the hand-in to one of the plurality of access points.

14. The target interface component of claim 13, wherein the pre-reserved resource further comprises a Walsh code defining a unique communication channel for use by the mobile station, and wherein the cellular identifier corresponds to a pilot identifier comprising a pseudonoise code or pseudonoise offset that is common to each of the plurality of access points.

15. The target interface component of claim 13, wherein the plurality of access points each comprise one of a plurality a femto access points each having at least a portion of a respective coverage area within a first cell of a cellular network carrying the call, wherein the plurality of femto access points is greater than a number of available pilot identifiers for use in the first cell, and wherein the plurality of access points comprises a subset of the plurality of femto access points.

16. A target interface component for performing a hand-in, comprising:
a communications module configured to receive a handoff request to handoff a call of a mobile station, wherein the handoff request comprises a cellular identifier corresponding to a pilot identifier of a pilot signal;
a target access point determiner configured to determine a plurality of access points that share the cell identifier, to initiate forwarding the handoff request to the plurality of access points that share the cell identifier; and
wherein the communications module is further configured to generate a handoff request acknowledgement comprising a pre-reserved resource that is common to the plurality of access points, wherein the pre-reserved resource enables the mobile station to communicate with the plurality of access points, and to transmit the handoff request acknowledgement to initiate the hand-in to one of the plurality of access points.

17. The target interface component of claim 16, wherein the handoff request further comprises a common frequency for the mobile station to use to communicate with any of the plurality of access points.

18. The target interface component of claim 16, wherein the pre-reserved resource further comprises a communication code defining a unique communication channel for use by the mobile station.

19. The target interface component of claim 18, wherein the cellular identifier corresponds to a pilot identifier comprising a pseudonoise code or pseudonoise offset that is common to each of the plurality of access points, and wherein the communication code further comprises a Walsh code.

20. The target interface component of claim 16, wherein the plurality of access points each comprise one of a plurality a femto access points each having at least a portion of a respective coverage area within a first cell of a cellular network carrying the call, wherein the plurality of femto access points is greater than a number of available pilot identifiers for use in the first cell, and wherein the plurality of access points comprises a subset of the plurality of femto access points.

21. The target interface component of claim 16, wherein the handoff request acknowledgement is generated based on receiving at least one access point-generated handoff request acknowledgement in response to the handoff request forwarded to the plurality of access points.

22. A method of performing a hand-in, comprising:
transmitting, by an access point, a pilot signal including a pilot identifier, wherein the pilot identifier is common to a plurality of access points within a macro cell of a cellular network;
receiving a handoff request to receive a hand-in of a call of a mobile station, wherein the handoff request is destined for the access point based on a cellular identifier corresponding to the pilot identifier; and
transmitting forward link traffic data according to a pre-reserved resource that is common to the plurality of access points to initiate the hand-in, wherein the pre-reserved resource enables the mobile station to communicate with the plurality of access points.

23. The method of claim 22, wherein the pre-reserved resource further comprises a communication code defining a unique communication channel for use by the mobile station.

24. The method of claim 23, wherein the pilot identifier comprises a pseudonoise code or pseudonoise offset that is common to each of the plurality of access points, and wherein the communication code further comprises a Walsh code.

25. The method of claim 22, wherein transmitting the forward link traffic data further comprises transmitting at a common frequency shared by the plurality of access points according to the pre-reserved resource.

26. The method of claim 22, further comprising transmitting a power control command to the mobile station, wherein the power control command reduces a transmit power of the mobile station.

27. The method of claim 26, wherein the power control command sets a reverse link coverage of the mobile station to be substantially equal to a forward link coverage of the access point.

28. The method of claim 22, further comprising receiving the hand-in of the call, and transmitting a command to the mobile station to switch to a non-common resource for communications after completing the hand-in.

29. The method of claim 22, wherein the plurality of access points each comprise one of a plurality a femto access points each having at least a portion of a respective coverage area within the macro cell, wherein the plurality of femto access points is greater than a number of available pilot identifiers for use in the macro cell, and wherein the plurality of access points comprises a subset of the plurality of femto access points.

30. The method of claim 22, further comprising:
receiving a handoff completion message based on receipt of the forward traffic data by the mobile station; and
receiving the hand-in of the call.

31. At least one processor for performing a hand-in, comprising:
a first module for transmitting, by an access point, a pilot signal including a pilot identifier, wherein the pilot identifier is common to a plurality of access points within a macro cell of a cellular network;
a second module for receiving a handoff request to receive a hand-in of a call of a mobile station, wherein the handoff request is destined for the access point based on a cellular identifier corresponding to the pilot identifier; and
a third module for transmitting forward link traffic data according to a pre-reserved resource that is common to the plurality of access points to initiate the hand-in, wherein the pre-reserved resource enables the mobile station to communicate with the plurality of access points.

32. The at least one processor of claim 31, further comprising a fourth module for receiving the hand-in of the call, and a fifth module for transmitting a command to the mobile station to switch to a non-common resource for communications after completing the hand-in.

33. The at least one processor of claim 31, wherein the plurality of access points each comprise one of a plurality a femto access points each having at least a portion of a respective coverage area within the macro cell, wherein the plurality of femto access points is greater than a number of available pilot identifiers for use in the macro cell, and wherein the plurality of access points comprises a subset of the plurality of femto access points.

34. A computer program product for performing a hand-in, comprising:
a computer-readable medium, comprising:
at least one instruction operable to cause a computer associated with an access point to transmit a pilot signal including a pilot identifier, wherein the pilot identifier is common to a plurality of access points within a macro cell of a cellular network;
at least one instruction operable to cause the computer to receive a handoff request to receive a hand-in of a call of a mobile station, wherein the handoff request is destined for the access point based on a cellular identifier corresponding to the pilot identifier; and
at least one instruction operable to cause the computer to transmit forward link traffic data according to a pre-reserved resource that is common to the plurality of access points to initiate the hand-in, wherein the pre-reserved resource enables the mobile station to communicate with the plurality of access points.

35. The product of claim 34, further comprising at least one instruction operable to cause the computer to receive the hand-in of the call, and at least one instruction operable to cause the computer to transmit a command to the mobile station to switch to a non-common resource for communications after completing the hand-in.

36. The product of claim 34, wherein the plurality of access points each comprise one of a plurality a femto access points each having at least a portion of a respective coverage area within the macro cell, wherein the plurality of femto access points is greater than a number of available pilot identifiers for use in the macro cell, and wherein the plurality of access points comprises a subset of the plurality of femto access points.

37. An access point, comprising:
means for transmitting a pilot signal including a pilot identifier, wherein the pilot identifier is common to a plurality of access points within a macro cell of a cellular network;
means for receiving a handoff request to receive a hand-in of a call of a mobile station, wherein the handoff request is destined for the access point based on a cellular identifier corresponding to the pilot identifier; and
means for transmitting forward link traffic data according to a pre-reserved resource that is common to the plurality of access points to initiate the hand-in, wherein the pre-reserved resource enables the mobile station to communicate with the plurality of access points.

38. The access point of claim 37, further comprising means for receiving the hand-in of the call, and means for transmitting a command to the mobile station to switch to a non-common resource for communications after completing the hand-in.

39. The access point of claim 37, wherein the plurality of access points each comprise one of a plurality a femto access points each having at least a portion of a respective coverage area within the macro cell, wherein the plurality of femto access points is greater than a number of available pilot identifiers for use in the macro cell, and wherein the plurality of access points comprises a subset of the plurality of femto access points.

40. An access point, comprising:
a communications module configured to transmit a pilot signal including a pilot identifier, wherein the pilot identifier is common to a plurality of access points within a macro cell of a cellular network, to receive a handoff request to receive a hand-in of a call of a mobile station, wherein the handoff request is destined for the access point based on a cellular identifier corresponding to the pilot identifier, and to transmit forward link traffic data according to a pre-reserved resource that is common to the plurality of access points to initiate the hand-in, wherein the pre-reserved resource enables the mobile station to communicate with the plurality of access points.

41. The access point of claim 40, wherein the pre-reserved resource further comprises a communication code defining a unique communication channel for use by the mobile station.

42. The access point of claim 41, wherein the pilot identifier comprises a pseudonoise code or pseudonoise offset that is common to each of the plurality of access points, and wherein the communication code further comprises a Walsh code.

43. The access point of claim 40, wherein the communications module is further configured to transmit the forward link traffic data at a common frequency shared by the plurality of access points according to the pre-reserved resource.

44. The access point of claim 40, wherein the communications module is further configured to transmit a power control command to the mobile station, wherein the power control command reduces a transmit power of the mobile station.

45. The access point of claim 44, wherein the power control command sets a reverse link coverage of the mobile station to be substantially equal to a forward link coverage of the access point.

46. The access point of claim 40, wherein the communications module is further configured to receive the hand-in of the call, and to transmit a command to the mobile station to switch to a non-common resource for communications after completing the hand-in.

47. The access point of claim 40, wherein the plurality of access points each comprise one of a plurality a femto access points each having at least a portion of a respective coverage area within the macro cell, wherein the plurality of femto access points is greater than a number of available pilot identifiers for use in the macro cell, and wherein the plurality of access points comprises a subset of the plurality of femto access points.

48. The access point of claim 40, wherein the communications module is further configured to receive a handoff completion message based on receipt of the forward traffic data by the mobile station, and to receive the hand-in of the call.

49. A method of communication, comprising:
receiving, at a mobile station located within a first cell, a pilot signal from an access point during a call carried by a source wireless network component different from the access point, wherein the pilot signal from the access point indicates a pilot identifier that is common to a plurality of access points within the first cell;
forwarding a measurement message including the pilot identifier to the source wireless network component;
receiving a handoff message that includes a pre-reserved resource that is common to the plurality of access points based on the pilot identifier, wherein the pre-reserved resource enables the mobile station to communicate with any of the plurality of access points;
receiving forward link traffic data from one of the plurality of access points; and
handing off the call to the one of the plurality of access points from which the forward link traffic data is received.

50. The method of claim 49, further comprising receiving a power control command from the one of the plurality of access points, wherein the power control command reduces a transmit power of the mobile station.

51. The method of claim 50, further comprising reducing the transmit power of the mobile station, according to the power control command, such that a reverse link coverage of the mobile station is substantially equal to a forward link coverage of the one of the plurality of access points.

52. The method of claim 49, further comprising receiving a command from the one of the plurality of access points to switch to a non-common resource for communications with the one of the plurality of access points after completing the handing off of the call.

53. The method of claim 49, wherein receiving the handoff message that includes the pre-reserved resource further comprises receiving a communication code defining a unique communication channel for use by the mobile station.

54. The method of claim 53, wherein the pilot identifier corresponds to a pseudonoise code or pseudonoise offset that is common to each of a plurality of access points, and wherein receiving the communication code further comprises receiving a Walsh code.

55. The method of claim 49, wherein receiving the handoff message that includes the pre-reserved resource further comprises receiving a common frequency for the mobile station to communicate with any of the plurality of access points.

56. The method of claim 49, wherein the plurality of access points each comprise one of a plurality a femto access points each having at least a portion of a respective coverage area within the first cell, wherein the plurality of femto access points is greater than a number of available pilot identifiers for use in the first cell, and wherein the plurality of access points comprises a subset of the plurality of femto access points.

57. At least one processor for communication, comprising:
a first module for receiving, at a mobile station located within a first cell, a pilot signal from an access point during a call carried by a source wireless network component different from the access point, wherein the pilot signal from the access point indicates a pilot identifier that is common to a plurality of access points within the first cell;
a second module for forwarding a measurement message including the pilot identifier to the source wireless network component;
a third module for receiving a handoff message that includes a pre-reserved resource that is common to the plurality of access points based on the pilot identifier, wherein the pre-reserved resource enables the mobile station to communicate with any of the plurality of access points;
a fourth module for receiving forward link traffic data from one of the plurality of access points; and
a fifth module for handing off the call to the one of the plurality of access points from which the forward link traffic data is received.

58. The at least one processor of claim 57, further comprising a sixth module for receiving a command from the one of the plurality of access points to switch to a non-common resource for communications with the one of the plurality of access points after completing the handing off of the call.

59. A computer program product, comprising:
a computer-readable medium, comprising:
at least one instruction operable to cause a computer to receive, at a mobile station located within a first cell, a pilot signal from an access point during a call carried by a source wireless network component different from the access point, wherein the pilot signal from the access point indicates a pilot identifier that is common to a plurality of access points within the first cell;
at least one instruction operable to cause the computer to forward a measurement message including the pilot identifier to the source wireless network component;
at least one instruction operable to cause the computer to receive a handoff message that includes a pre-reserved resource that is common to the plurality of access points based on the pilot identifier, wherein the pre-reserved resource enables the mobile station to communicate with any of the plurality of access points;
at least one instruction operable to cause the computer to receive forward link traffic data from one of the plurality of access points; and
at least one instruction operable to cause the computer to hand off the call to the one of the plurality of access points from which the forward link traffic data is received.

60. The computer program product of claim 59, further comprising at least one instruction operable to cause the computer to receive a command from the one of the plurality of access points to switch to a non-common resource for communications with the one of the plurality of access points after completing the handing off of the call.

61. A mobile station, comprising:
means for receiving, at a mobile station located within a first cell, a pilot signal from an access point during a call carried by a source wireless network component different from the access point, wherein the pilot signal from the access point indicates a pilot identifier that is common to a plurality of access points within the first cell;
means for forwarding a measurement message including the pilot identifier to the source wireless network component;
means for receiving a handoff message that includes a pre-reserved resource that is common to the plurality of access points based on the pilot identifier, wherein the pre-reserved resource enables the mobile station to communicate with any of the plurality of access points;
means for receiving forward link traffic data from one of the plurality of access points; and
means for handing off the call to the one of the plurality of access points from which the forward link traffic data is received.

62. The mobile station of claim 61, further comprising means for receiving a command from the one of the plurality of access points to switch to a non-common resource for communications with the one of the plurality of access points after completing the handing off of the call.

63. A mobile station, comprising:
a processor; and
a memory comprising instructions executable by the processor to:
receive, when the mobile station is located within a first cell, a pilot signal from an access point during a call carried by a source wireless network component different from the access point, wherein the pilot signal from the access point indicates a pilot identifier that is common to a plurality of access points within the first cell;
forward a measurement message including the pilot identifier to the source wireless network component;
receive a handoff message that includes a pre-reserved resource that is common to the plurality of access points based on the pilot identifier, wherein the pre-reserved resource enables the mobile station to communicate with any of the plurality of access points;
receive forward link traffic data from one of the plurality of access points; and
hand off the call to the one of the plurality of access points from which the forward link traffic data is received.

64. The mobile station of claim 63, further comprising instructions executable to receive a power control command from the one of the plurality of access points, wherein the power control command reduces a transmit power of the mobile station.

65. The mobile station of claim 64, further comprising instructions executable to reduce the transmit power of the mobile station, according to the power control command, such that a reverse link coverage of the mobile station is substantially equal to a forward link coverage of the one of the plurality of access points.

66. The mobile station of claim 63, further comprising instructions executable to receive a command from the one of the plurality of access points to switch to a non-common resource for communications with the one of the plurality of access points after completing the hand off of the call.

67. The mobile station of claim 63, wherein the pre-reserved resource further comprises a communication code defining a unique communication channel for use by the mobile station.

68. The mobile station of claim 67, wherein the pilot identifier corresponds to a pseudonoise code or pseudonoise offset that is common to each of a plurality of femto access points, and wherein the communication code further comprises a Walsh code.

69. The mobile station of claim 63, wherein the pre-reserved resource further comprises a common frequency for the mobile station to communicate with any of the plurality of access points.

70. The mobile station of claim 63, wherein the plurality of access points each comprise one of a plurality a femto access points each having at least a portion of a respective coverage area within the first cell, wherein the plurality of femto access points is greater than a number of available pilot identifiers for use in the first cell, and wherein the plurality of access points comprises a subset of the plurality of femto access points.
